(19) United States
(12) Patent Application Publication
(10) Pub. No.: US 2002/0014576 A1
(43) Pub. Date: Feb. 7, 2002

(54) LIGHT EMITTING ELEMENT PROTECTING DEVICE AND METHOD THEREOF

(75) Inventor: Tomio MITUHASHI, Kawasaki (JP)

Correspondence Address: Staas &, Halsey, 700 11th Street, NW, Suite 500, Washington, DC, 20001, US, (202) 434-1500, (202) 434-1501

(73) Assignee: FUJITSU LIMITED, Kawasaki, 211 (JP)

(21) Appl. No.: 08/917,360

(22) Filed: Aug. 26, 1997

(30) Foreign Application Priority Data
Jan. 10, 1997 (JP) 09-002598

(51) Int. Cl. G01J 1/32

(52) U.S. Cl. 250/205

(57) ABSTRACT

### Abstract of Disclosure

A driving unit drives a light emitting unit, so that a light detecting unit detects light output from the light emitting unit, and a detection signal detected by the light detecting unit is transmitted to a controlling unit. When the detection signal from the light detecting unit is transmitted for a predetermined amount of time or more, the controlling unit stops a driving operation of the light emitting unit, which is performed by the driving unit, and protects the light emitting unit from being destroyed due to an overcurrent.

### Background of Invention

Field of the Invention

The present invention relates to a light emitting element protecting device and a method thereof. Particularly, the present invention is preferable for the case in which a light emitting diode is prevented from being destroyed due to an electric overcurrent.

Related Art of the Invention

Currently, communications between personal computers, between a personal computer and a mobile phone, between a personal computer and a printer, etc. are implemented by an optical communication using a light emitting diode. If the light emitting diode is made to continuously emit light, the value of an electric current which can be applied to the light emitting diode is approximately between 20mA and 50mA. In a field such as an optical communication field which requires an optical intensity whose value is equal to or greater than a predetermined value, an electric current of 500mA or so is instantaneously applied, and a light emitting diode is made to perform pulse-light-emission, in order to secure a required optical intensity. For example, a light emitting diode conforming to an IRDA (Infrared Data Association) standard can be cited.

A control LSI which controls a light emitting diode and serves as also an RS232C interface is available when the light emitting diode is used in an optical communication performed by a personal computer. The value of the RS232C (as above) defaults to a high level, while that of the IR communication defaults to a low level. Accordingly, a continuous light emitting signal is transmitted to a light emitting diode, and an electric current equal to or higher than 50mA or so flows into the light emitting diode for a long period (500ms or more), which destroys the light emitting diode when power is turned on, during the reset period, or a switching period of a control LSI, etc.

Fig.1 is a circuit diagram showing the configuration of an infrared ray module for use in a conventional optical communication system.

In this figure, VCC indicates a power supply voltage, and its value is normally set to 5V; R11 indicates a resistor, and its value is normally set to several ohms; LED6 indicates a light emitting diode; TR6 indicates an NPN bipolar transistor; and 71 indicates a buffer.

The collector terminal of the NPN bipolar transistor TR6 is connected with the cathode terminal of the light emitting diode LED6. The base terminal of the NPN bipolar transistor TR6 is connected with the TXD (transmission data) signal input terminal via the buffer 71. The emitter terminal of the NPN bipolar transistor TR6 is connected with ground. The anode terminal of the light emitting diode LED6 is connected to the power supply voltage VCC via the resistor R11.

When a TXD signal is input to the NPN bipolar transistor TR6, the NPN bipolar transistor TR6 is turned on if the TXD signal is driven high. As a result, an electric current IL of 300mA-450mA or so flows into the light emitting diode LED6, from which an infrared ray is emitted.

Fig.2 is a timing chart showing the operations of the infrared ray module shown in Fig.1.

As shown in Fig.2(A), a TXD signal being transmitted is a pulse signal. The NPN bipolar transistor TR6 is switched between ON and OFF in correspondence with the pulse operation of the TXD signal. As a result, an electric current IL flows into the light emitting diode LED6 in a pulse-like manner, and the light emitting diode LED6 emits pulses of infrared light, as shown in Fig.2(B).

When a transmission period is changed to a reset period, the TXD signal is driven high and the NPN bipolar transistor TR6 remains ON. As a result, the electric current IL of 300mA-450mA continuously flows into the light emitting diode LED6. Since the light emitting diode LED6 continuously emits light, it is destroyed in the course of the continuous light emission.

Because the method for making the light emitting diode LED6 perform pulse-light-emission by applying an electric current equal to or higher than a rated value can possibly destroy the light emitting diode LED6 as described above, various methods for protecting a light emitting diode have been proposed.

Fig.3 is a circuit diagram exemplifying a conventional method for protecting a light emitting diode.

In this figure, VCC indicates a power supply voltage, and its value is normally set to 5V; R12 and R13 indicate resistors, and the value of the resistor R12 is normally set to several ohms; 81 indicates a differential circuit; LED7 indicates a light emitting diode; TR7 indicates an NPN bipolar transistor; and C5 indicates a capacitor.

The collector terminal of the NPN bipolar transistor TR7 is connected with the cathode terminal of the light emitting diode LED7. The base terminal of the NPN bipolar transistor TR7 is connected with the TXD (Transmitter Data) signal input terminal via the differential circuit 81. The emitter terminal of the NPN bipolar transistor TR7 is connected with ground. The anode terminal of the light emitting diode LED7 is connected to the power supply voltage VCC via the resistor R12.

The differential circuit 81 is composed of the capacitor C5 and the resistor R13. The capacitor C5 is connected between the TXD signal input terminal and the base terminal of the NPN bipolar transistor TR7. The resistor R13 is connected between the base terminal of the NPN bipolar transistor TR7 and ground.

A TXD signal is input to the NPN bipolar transistor TR7 after its direct current component is removed by the differential circuit 81. As a result, the period during which the NPN bipolar transistor TR7 is ON is restricted based on the time constant of the differential circuit 81, thereby protecting the light emitting diode LED7 from being destroyed.

Figs.4 is a timing chart showing the operations of the infrared ray module shown in Fig.3. The time constant of the differential circuit 81 is set so that an input signal to the NPN bipolar transistor TR7 reaches a threshold voltage Vth of the NPN bipolar transistor TR7 before the light emitting diode LED7 is destroyed when the light emitting diode LED7 is made to continuously emit light.

As shown in Fig.4(A), the information transmission speed achieved by the TXD signal being transmitted is 2.4Kbps-4Mbps (bits per second). Accordingly, the TXD signal which is being transmitted and passed through the differential circuit 81 is input to the NPN bipolar transistor TR7 almost unchanged as shown in Fig. 4(B). The NPN bipolar transistor is switched between ON and OFF in correspondence with the pulse operation of the TXD signal. As a result, the electric current IL flows into the light emitting diode LED7 in a pulse-like manner as shown in Fig. 4(C). The light emitting diode LED7 performs pulse-light-emission.

When the transmission period is changed to the reset period, the TXD signal is driven high, and the NPN bipolar transistor TR7 remains ON. The TXD signal passes through the differential circuit 81, so that the level of the input signal to the NPN bipolar transistor TR7 becomes lower based on the time constant of the differential circuit 81. When the level of the input signal to the NPN bipolar transistor TR7 reaches a threshold voltage Vth of the NPN bipolar transistor TR7, the NPN bipolar transistor TR7 changes from ON to OFF and the electric current IL is shut off. As a result, the light emitting diode LED7 stops emitting light.

Additionally, as disclosed by the Japanese Laid-open Patent Publication (Tokkaisho) No. 56-2679 or the Japanese Laid-open Patent Publication (Tokkaisho) No. 58-50785, there is a method for protecting a light emitting diode by detecting an amount of time during which electricity is applied to the light emitting diode, and shutting off an electric current flowing into the light emitting diode when the electricity-applied time of the light emitting diode reaches a predetermined value.

With the method for protecting a light emitting diode shown in Fig.3, however, an undershoot may sometimes occur in an input signal to the NPN bipolar transistor TR7 when the TXD signal changes from ON to OFF after the reset period shown in Fig.4 terminates.

Therefore, the reverse tolerable voltage of the NPN bipolar transistor TR7 must not be exceeded. If the undershoot exceeds the reverse tolerable voltage of the NPN bipolar transistor TR7, the NPN bipolar transistor TR7 can possibly be destroyed.

Additionally, with this method, even if the size of an electric current flowing into the light emitting diode varies, an amount of time required until the electric current flowing into the light emitting diode is shut off remains unchanged, and it is impossible to change the amount of time required before the electric current flowing into the light emitting diode is shut off, depending on the size of the electric current flowing into the light emitting diode.

As a result, using the method for shutting off the electric current applied to the light emitting diode when the electricity-applied time of the light emitting diode reaches a predetermined amount of time, the diode may sometimes be destroyed when a surge current instantaneously flows into the light emitting diode.

### Summary of Invention

An object of the present invention is to provide a light-emitting element protecting device for allowing the reliability of protection of a light emitting element to be improved and a method thereof.

To overcome the above described problems, a driving unit for driving a light emitting unit is controlled based on a detection signal output from a light detecting unit, according to the present invention.

This process allows a driving input to control the light emitting unit based on the light output from the light emitting unit.

As a result, the operation performed by the light emitting unit can be stopped when the light emitting unit outputs a light for a predetermined amount of time or more, thereby protecting a light emitting element from being destroyed due to an overcurrent.

According to an embodiment of the present invention, the driving operation of the light emitting unit, which is performed by the driving unit, is cancelled when an integration result of the detecting signal of the light detecting means reaches a predetermined value.

This process allows an electric current flowing into a light emitting element to be shut off based on an electricity-applied time and the size of an electric current flowing into the light emitting element. Accordingly, even if a strong light is output from the light emitting unit, the result of an integration of a detection signal reaches a predetermined value in a short period, thereby stopping the light emitting operation of the light emitting unit, and improving the reliability of protection of a light emitting element.

According to another embodiment of the present invention, a photoelectric current from a photodiode or a photo-transistor is integrated by a CR circuit, and an input signal to a transistor which drives a light emitting diode is shut off after a predetermined amount of time has elapsed from when a value integrated by the CR circuit reaches a predetermined value.

This process allows an input signal to the transistor which drives the light emitting diode to be shut off after the predetermined amount of time has elapsed from when the value integrated by the CR circuit reaches the predetermined value, and allows the light emitting diode to stop emitting light. As a result, the light emitting diode can be protected from being destroyed due to an overcurrent. Furthermore, if the light emitting diode stops emitting light, a photoelectric current from a photodiode or a photo-transistor will not flow into the CR circuit. The electric charge stored in a capacitor of the CR circuit is therefore discharged via the resistance of the CR circuit, thereby driving the light emitting diode again by the transistor.

According to a further embodiment of the present invention, the value integrated by the CR circuit is input to an inverter in order to switch between ON and OFF. When the integrated value of an output from the inverter reaches a predetermined value or more, a light emitting diode control implemented by a transistor is shut off.

This process allows the duration during which the light emitting diode stops emitting light to be arbitrarily set. If an input signal to a transistor is transmission data, it can be properly transmitted. If the input signal to the transistor is a direct current signal of a high level, it is converted into a pulse signal. As a result, the light emitting diode can be protected from being destroyed due to the direct current signal of a high level.

According to a still further embodiment of the present invention, a driving unit for driving a light emitting unit is controlled based on a detection signal output from a temperature detecting unit.

This process allows a driving input to the light emitting unit to be controlled based on the temperature of the light emitting unit. Accordingly, an electric current of a high level flows into the light emitting unit for a predetermined amount of time or more. When light is output from the light emitting unit for a predetermined amount of time or more, the temperature of the light emitting unit rises beyond a normal temperature range. As a result, it can be determined that an overcurrent flows into the light emitting unit by detecting the temperature of the light emitting unit, thereby protecting a light emitting element from being destroyed due to the overcurrent.

According to a still further embodiment of the present invention, it is determined by a comparator whether or not the voltage value of a thermistor reaches a predetermined value, so that it is determined whether or not an overcurrent flows into the light emitting unit.

This process allows a change of the temperature of the light emitting unit to be detected with high sensitivity, and allows the reliability of protection of a light emitting element to be improved.

According to a still further embodiment of the present invention, it is determined whether or not an overcurrent flows into the light emitting unit based on an output value from a monolithic integrated circuit temperature transducer.

This process allows circuitry to be simplified when a change of the temperature of the light emitting unit is to be detected. Because the monolithic integrated circuit temperature transducer detects the temperature according to a change of a forward energy gap of a P-N junction, the monolithic integrated circuit temperature transducer can be easily integrated with a transistor or a light emitting diode. As a result, mass-productivity as well as a reduction in size and weight can be improved.

According to a still further embodiment of the present invention, an input signal having a predetermined pulse width is made to pass through as it is, while an input signal having a pulse width wider than the predetermined pulse width is converted into a signal having the predetermined pulse width, and provided to a driving unit.

This process allows transmission data to be optically transmitted if an input signal to the driving unit is the transmission data. If the input signal to the driving unit is a direct current signal, it is converted into a pulse signal. As a result, the light emitting unit can be protected from being destroyed due to a direct current signal of a high level.

According to a still further embodiment of the present invention, a pulse controlling unit is implemented by a monostable circuit.

The implementation by the monostable circuit can protect a light emitting diode from being destroyed due to an overcurrent by using simplified circuitry which allows a light emitting element to be protected from being destroyed due to an overcurrent. Additionally, the monostable circuit can be easily integrated with a transistor or a light emitting diode, thereby allowing improved mass-productivity in addition to reducing the size and weight.

### Brief Description of Drawings

Fig.1 is a circuit diagram showing the configuration of a conventional infrared ray module;

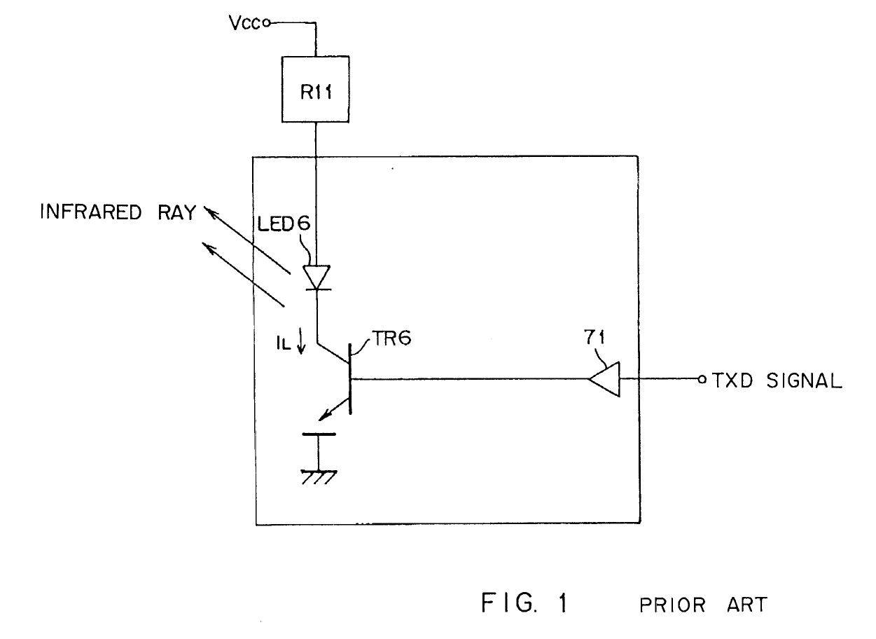

Fig.2 is a timing chart showing the operations of the infrared ray module shown in Fig.19;

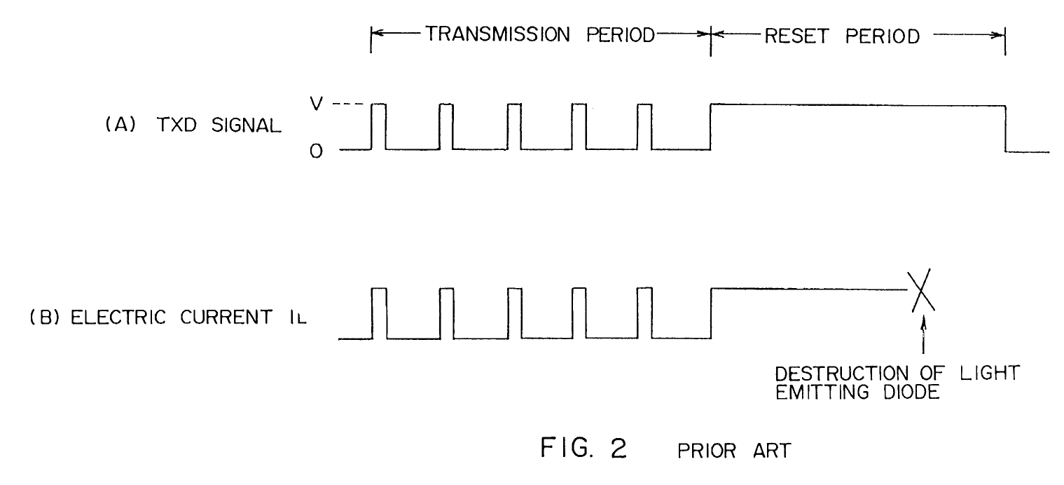

Fig.3 is a circuit diagram showing the configuration of a conventional light emitting diode protecting device;

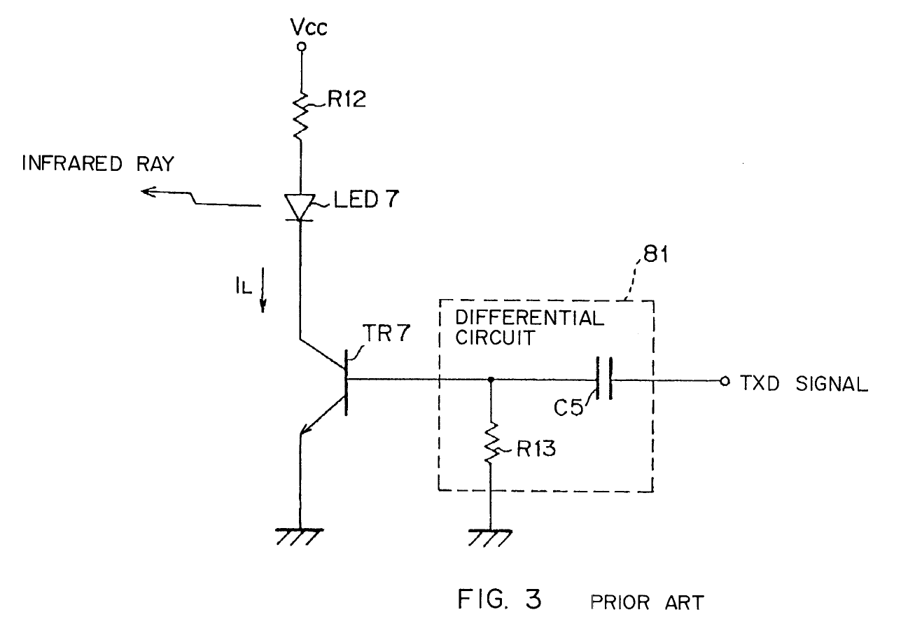

Fig.4 is a timing chart showing the operations of the light emitting diode protecting device shown in Fig.3;

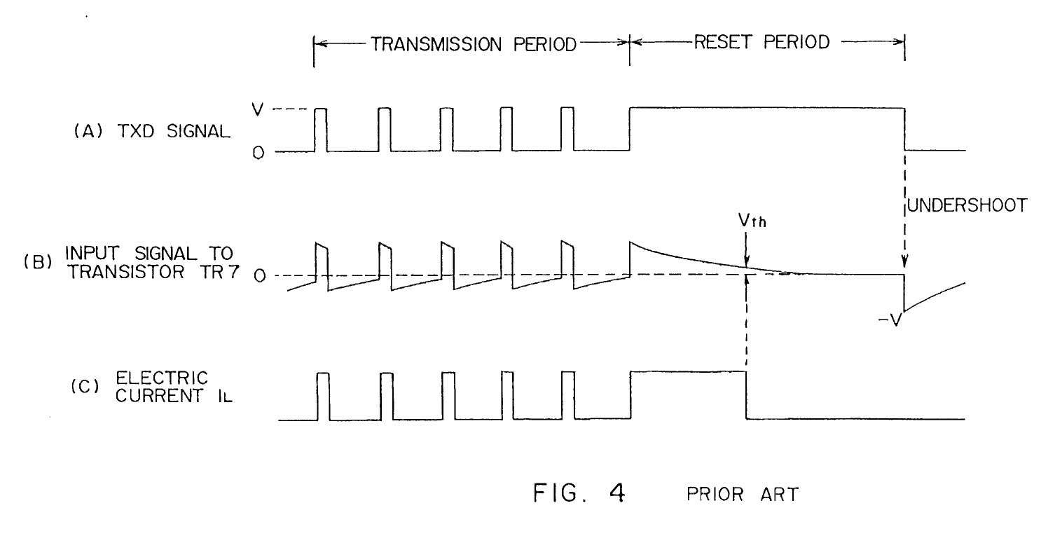

Fig.5 is a block diagram showing the configuration of a light emitting element protecting device according to a first embodiment of the present invention;

Fig.6 is a block diagram exemplifying the configuration of a controlling unit 4 shown in Fig.5;

Fig.7 is a schematic diagram showing the configuration of a light emitting element protecting device according to a second embodiment of the present invention;

Fig.8 shows a truth table indicating the operations of the light emitting element protecting device shown in Fig.7;

Fig.9 is a timing chart showing the operations of the light emitting element protecting device shown in Fig.7;

Fig.10 is a schematic diagram showing an example in which a light emitting element protecting device according to an embodiment of the present invention is applied to an optical communication system of a notebook computer;

Fig.11 is a schematic diagram showing the configuration of a light emitting element protecting device according to a third embodiment of the present invention;

Fig.12 is a block diagram showing the configuration of a light emitting element protecting device according to a fourth embodiment of the present invention;

Fig.13 is a schematic diagram showing the configuration of a light emitting element protecting device according to a fifth embodiment of the present invention;

Fig.14 is a schematic diagram showing the configuration of a light emitting element protecting device according to a sixth embodiment of the present invention;

Fig.15 is a block diagram showing the configuration of a light emitting element protecting device according to a seventh embodiment of the present invention;

Fig.16 is a schematic diagram showing the configuration of a light emitting element protecting device according to an eighth embodiment of the present invention;

Fig.17 is a schematic diagram exemplifying the configuration of the monostable circuit shown in Fig.16;

Fig.18 shows logic symbols representing the monostable circuit shown in Fig.17;

Fig.19 is a functional table indicating the operations of the monostable circuit shown in Fig.17;

Fig.20 is a circuit diagram showing the configuration of a circuit which is externally attached to the monostable circuit shown in Fig.17;

Fig.21 is a truth table indicating the operations of the light emitting element protecting device shown in Fig.16; and

Fig.22 is a timing chart showing the operations of the light emitting element protecting device shown in Fig.16.

### Detailed Description

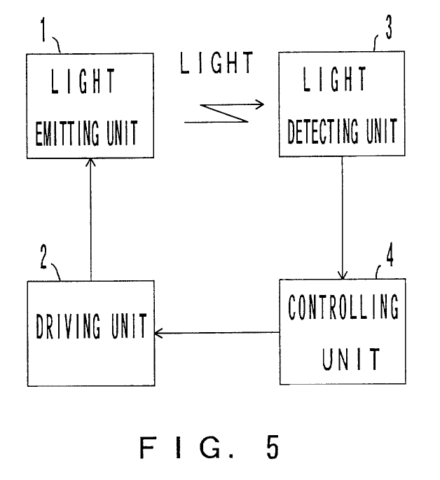

Fig.5 is a block diagram showing the configuration of a light emitting element protecting device according to the first embodiment of the present invention.

In this figure, a light emitting unit 1 is intended to emit light based on a driving input. It is, for example, a light emitting diode or a laser diode.

A driving unit 2 is intended to provide a driving input to the light emitting unit 1, and drive the light emitting unit 1. It is, for example, a bipolar transistor, a field-effect transistor, etc.

A light detecting unit 3 is intended to detect light output from the light emitting unit 1. It is, for example, a photo-transistor, photodiode, avalanche photodiode, etc.

A controlling unit 4 is intended to control the driving unit 2 based on a detection signal output from the light detecting unit 3. For example, if the detection signal from the light detecting unit 3 is equal to or higher than a predetermined value, the controlling unit 4 can be implemented so as to stop the driving unit 2 from driving the light emitting unit 1. Also, if a detection signal whose value is equal to or higher than the predetermined value, is transmitted from the light detecting unit 3 for a predetermined amount of time or more, the controlling unit 4 can be implemented so as to stop the driving unit 2 from driving the light emitting unit 1. Furthermore, when the integrated value of the detection signal from the light detecting unit 3 reaches a predetermined value or more, the controlling unit 4 can be implemented so as to stop the driving unit 2 from driving the light emitting unit 1.

The light detecting unit 3 is intended to detect light output from the light emitting unit 1, which is driven by the driving unit 2. The detection signal detected by the light detecting unit 3 is transmitted to the controlling unit 4. The controlling unit 4 stops the driving unit 2 from driving the light emitting unit 1, if the detection signal from the light detecting unit 3 is transmitted for a predetermined amount of time or more.

This process can stop the light emitting unit 1 from emitting light, if light is output from the light emitting unit 1 for a predetermined amount of time or more. As a result, the light emitting unit 1 can be protected from being destroyed due to an overcurrent.

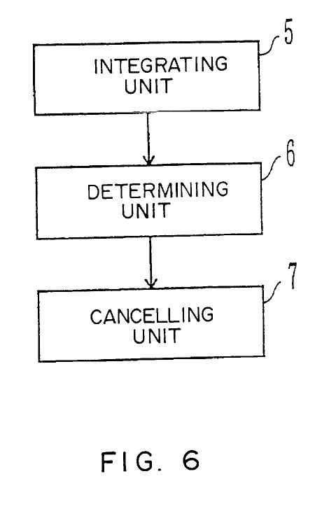

Fig.6 is a block diagram exemplifying the configuration of the controlling unit 4 shown in Fig.5.

In this figure, an integrating unit 5 integrates a detection signal output from the light detecting unit 3; a determining unit 6 determines whether or not the result of the integration performed by the integrating unit 5 reaches a predetermined value; and a cancelling unit 7 cancels the driving operation of the light emitting unit 1, which is performed by the driving unit 2.

The light detecting unit 3 detects the light output from the light emitting unit 1 according to the driving operation of the light emitting unit 1, which is performed by the driving unit 2. The detection signal detected by the light detecting unit 3 is transmitted to the integrating unit 5. The integrating unit 5 integrates the detection signal from the light detecting unit 3. When the determining unit 6 determines that the result of integration by the integrating unit 5 reaches a predetermined value, the cancelling unit 7 stops the driving unit 2 from driving the light emitting unit 1, so that the emission of the light emitting unit 1 is stopped.

By integrating the detection signal detected by the light detecting unit 3 as described above, an electric current flowing into the light emitting unit 1 can be stopped based on the light emission time and intensity of the light emitting unit 1. Accordingly, even if strong light is output from the light emitting unit 1, the result of integration of the detection signal reaches a predetermined value in a short period. As a result, the light emission operation of the light emitting unit 1 can be stopped in a short period.

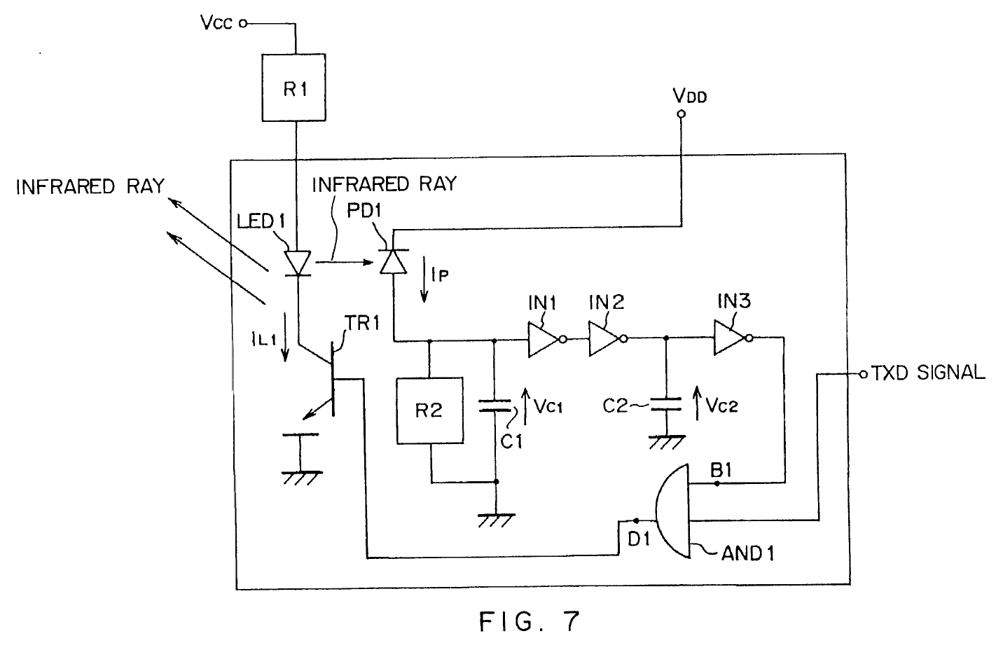

Fig.7 is a schematic diagram showing the configuration of a light emitting element protecting device according to the second embodiment of the present invention.

In this figure, VCC indicates a power supply voltage, and its value is normally set to 5V; R1 and R2 indicate resistors, and their values are respectively and normally set to several ohms and 5K ohms or so; C1 and C2 indicate capacitors, and their values are respectively and approximately set to 40nF and 2ΦF; LED1 indicates a light emitting diode; TR1 indicates an NPN bipolar transistor which drives the light emitting diode LED 1; PD1 indicates a photodiode which detects an infrared ray from the light emitting diode LED1; IN1, IN2, and IN3 indicate inverters; and AND1 indicates an AND circuit.

A collector terminal of the NPN bipolar transistor TR1 is connected with a cathode terminal of the light emitting diode LED1. A base terminal of the NPN bipolar transistor TR1 is connected with an output terminal of the AND circuit AND1. An emitter terminal of the NPN bipolar transistor TR1 is connected to ground. An anode terminal of the light emitting diode LED1 is connected to a power supply voltage VCC via the resistor R1.

The resistor R2 and the capacitor C1 are connected in parallel so as to configure an RC circuit. One end of the RC circuit is connected with an anode terminal of the photodiode PD1 and an input terminal of the inverter IN1. The other end of the RC circuit is connected to ground. A cathode terminal of the photodiode PD1 is connected to a power supply voltage VDD.

The inverters IN1, IN2, and IN3 are connected in series. The grounded capacitor C2 is connected between the inverters IN2 and IN3. A first input terminal of the AND circuit AND1 is connected with an output terminal of the inverter IN3. A second input terminal of the AND circuit AND1 is connected with an input terminal of the TXD signal.

Since the light emitting diode LED1 does not emit light until the TXD signal is input to the AND circuit AND1, a photoelectric current IP does not flow into the photodiode PD1. Accordingly, the voltage VC1 of the capacitor C1 becomes "0", and also the voltage VC2 of the capacitor C2 remains "0". The level of the voltage VC2 of the capacitor C2 is inverted by the inverter IN3, so that the electric potential at a point B1 of the first input terminal of the AND circuit AND1 is driven high.

If the TXD signal is input to the AND circuit AND1 in this state, this signal passes through the AND circuit AND1 unchanged, and the electric potential at a point D1 of the output terminal of the AND circuit AND1 will become a value corresponding to the TXD signal.

As a result, the TXD signal which passed through the AND circuit AND1 flows into the base terminal of the NPN bipolar transistor TR1. When the TXD signal is driven high, the NPN bipolar transistor TR1 is turned on. Accordingly, an electric current IL1 of 300mA-450mA flows into the light emitting diode LED1, and an infrared ray is output from the light emitting diode LED1.

Part of the infrared ray output from the light emitting diode LED1 is input to the photodiode PD1, and the photoelectric current IP flows into the photodiode PD1. The photoelectric current IP flows into the RC circuit which is composed of the resistor R2 and the capacitor C1. As a result, an electric charge is stored in the capacitor C1. The electric charge stored in the capacitor C1 generates the voltage VC1 in the capacitor C1, and the voltage C1 is input to the inverter IN1.

When an infrared ray is output from the light emitting diode LED1 for a predetermined amount of time or more, and the voltage VC1 reaches a threshold voltage Vth1 of the inverter IN1, the output voltage of the inverter IN1 makes a high-to-low transition. As a result, the inverter IN1 outputs a low level voltage to the inverter IN2. When the low level voltage is input from the inverter IN1 to the inverter IN2, the output voltage of the inverter IN2 makes a low-to-high transition. As a result, the inverter IN2 outputs a high level voltage to the capacitor C2.

Accordingly, an electric current determined according to the capacity of the capacitor and output impedance of the inverter IN2 flows into the capacitor C2, and an electric charge is stored in the capacitor C2. Then, the electric charge stored in the capacitor C2 generates the voltage VC2 in the capacitor C2, and the voltage VC2 is input to the inverter IN3.

When the voltage VC2 reaches the threshold voltage Vth2 of the inverter IN3, the output voltage of the inverter IN3 makes a high-to-low transition. The inverter IN3 outputs a low level voltage to the AND circuit AND1. When the low level voltage is input from the inverter IN3, the AND circuit AND1 prevents the TXD signal from passing through the circuit itself.

The TXD signal is stopped at the AND circuit AND1 and not transmitted to the NPN bipolar transistor TR1, the input signal to the NPN bipolar transistor TR1 is driven low. Accordingly, the electric current IL1 does not flow into the light emitting diode LED1, and the light emitting diode LED1 stops emitting light.

Similarly, the emission of the light emitting diode LED1 is switched between ON and OFF while the TXD signal goes high, thereby protecting the light emitting diode LED1 from being destroyed due to an overcurrent.

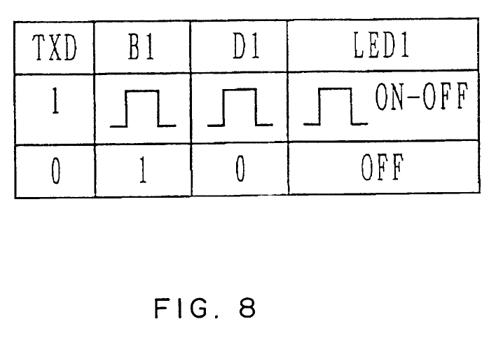

Fig.8 is a truth table indicating the operations of the light emitting element protecting device shown in Fig.7. When the logical value of the TXD signal is "1" in this figure, the electric potential at the point B1 will become a pulse form. Accordingly, also the electric potential at the point D1 will become a pulse form, and the light emitting diode LED1 is switched between ON and OFF. If the logical value of the TXD signal is "0", the logical values at the points B1 and D1 will respectively become "1" and "0". As a result, the light emitting diode LED1 will be turned off.

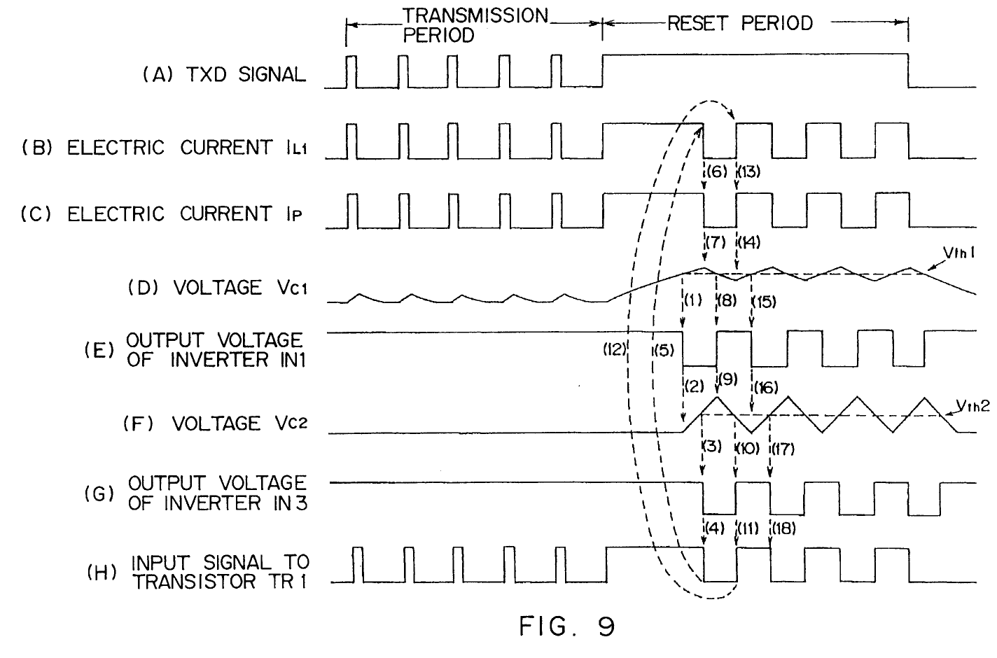

Fig.9 is a timing chart showing the operations of the light emitting element protecting device shown in Fig.7. If the TXD signal remains high for a long period, the time constant of the CR circuit is set so that an output from the AND circuit AND1 will be driven low, and the TXD signal during a data transmission period will properly pass through the AND circuit AND1 before the light emitting diode LED1 is destroyed.

Assuming that an information transmission speed implemented by the TXD signal during the data transmission period is approximately 2.4Kbps-4Mbps, and a maximum duty factor is 20%, the time constant of the CR circuit composed of the resistor R2 and the capacitor C1 will be set to approximately 100Φs. Additionally, the time constant of the integrating circuit composed of the output impedance of the inverter IN2 and the capacitor C2 will be set to approximately 50Φs.

Also assume that the low level voltages of the inverters IN1, IN2, and IN3 are set to 0V, their high voltages are set to 5V, and their threshold voltages at which the inverters make a high-to-low transition are set to 1.5V.

During the transmission period of the TXD signal shown in Fig.9(A), the signal passes through the AND circuit AND1, and input to the base terminal of the NPN bipolar transistor TR1 as it is. The NPN bipolar transistor TR1 is switched between ON and OFF in correspondence with the pulse operation of the TXD signal. As a result, the electric current IL1 flows into the light emitting diode LED1 in a pulse-like manner, and the light emitting diode LED1 performs pulse-light-emission.

Part of an infrared ray from the light emitting diode LED1 is input to the photodiode PD1, and the photoelectric current IP shown in Fig.9(C) flows into the photodiode PD1 in a pulse-like manner. The photoelectric current IP flows into the RC circuit composed of the resistor R2 and the capacitor C1, and an electric charge is stored in the capacitor C1. The electric charge stored in the capacitor C1 generates the voltage VC1 in the capacitor C1, and the voltage VC1 is then input to the inverter IN1.

Since the electric charge stored in the capacitor C1 is discharged via the resistor R2, the voltage VC1 of the capacitor C1 begins to drop when the photoelectric current I_{P} is turned off. As a result, the voltage VC1 becomes 0V after a predetermined amount of time elapses. Because the electric charge of the capacitor C1 is repeatedly charged and discharged in correspondence with ON/OFF of the photoelectric current IP as shown in Fig.9(D), the time constant of the RC circuit composed of the resistor R2 and the capacitor C1 is set so that the voltage VC1 of the capacitor C1 does not reach the threshold voltage Vth1 of the inverter IN1 during the transmission period of the TXD signal shown in Fig.9(A).

As a result, the inverter IN1 remains high as shown in Fig.9(E), while the inverter IN2 remains low. The voltage VC2 of the capacitor C2 shown in Fig.9F therefore remains 0V.

If the voltage VC2 of the capacitor C2 is 0V, the output voltage of the inverter IN3 is driven high as shown in Fig.9(G). The AND circuit AND1 continues to transmit the TXD signal to the base terminal of the NPN bipolar transistor TR1.

When the transmission period is changed to a reset period, the TXD signal is driven high as shown in Fig.9(A), and the NPN bipolar transistor TR1 remains ON. As a result, the electric current IL1 of approximately 300mA-450mA flows into the light emitting diode LED1, and an infrared ray is output from the light emitting diode LED1.

Part of the infrared ray output from the light emitting diode LED1 is input to the photodiode PD1, and the photoelectric current IP flows into the photodiode PD1 as shown in Fig.9(C). The photoelectric current IP flows into the RC circuit composed of the resistor R2 and the capacitor C1, and an electric charge is stored in the capacitor C1. The electric charge stored in the capacitor C1 generates the voltage VC1 in the capacitor C1, and this voltage is then input to the inverter IN1.

When the infrared ray is output from the light emitting diode LED1 for a predetermined amount of time or more, and the voltage VC1 reaches the threshold voltage Vth1 of the inverter IN1, the output voltage of the inverter IN1 makes a high-to-low transition. The inverter IN1 outputs a low level voltage to the inverter IN2 (Fig.9(1)). When the low level voltage is input from the inverter IN1, the inverter IN2 outputs a high level voltage to the capacitor C2 (Fig.9(2)). As a result, an electric current determined according to the capacity value of the capacitor C2 and the output impedance of the inverter IN2 flows into the capacitor C2, and an electric charge is stored in the capacitor C2. The electric charge stored in the capacitor C2 generates the voltage VC2 in the capacitor C2. The voltage VC2 is then input to the inverter IN3.

When the electric charge is stored in the capacitor C2 and the voltage VC2 reaches the threshold voltage Vth2 of the inverter IN3, the output voltage of the inverter IN3 makes a high-to-low transition (Fig.9(3)). As a result, the inverter IN3 outputs a low level voltage to the AND circuit AND1. When the low level voltage is input from the inverter IN3, the AND circuit AND1 prevents the TXD signal from flowing into the base terminal of the NPN bipolar transistor TR1, and drives the input signal to the base terminal of the NPN bipolar transistor TR1 low (Fig.9(4)).

When the input signal to the base terminal of the NPN bipolar transistor TR1 is driven low, the electric current IL1 does not flow into the light emitting diode LED1 (Fig.9(5)). As a result, the light emitting diode LED1 stops emitting light, and the photoelectric current IP does not flow into the photodiode PD1 (Fig.9(6)). The electric charge stored in the capacitor C1 is discharged via the resistor R2, and the voltage VC1 of the capacitor C1 begins to drop (Fig.9(7)).

When the voltage VC1 of the capacitor C1 reaches the threshold voltage Vth1 of the inverter IN1, the output voltage of the inverter IN1 makes a low-to-high transition (Fig.9(8)). As a result, the inverter IN1 outputs a high level voltage to the inverter IN2. When the high level voltage is input from the inverter IN1, the output voltage of the inverter IN2 makes a high-to-low transition, and the inverter IN2 outputs a low level voltage to the capacitor C2 (Fig.9(9)). Therefore, the electric charge stored in the capacitor C2 is discharged via the inverter IN2, and the voltage VC2 of the capacitor C2 begins to drop.

When the electric charge stored in the capacitor C2 is discharged and the voltage VC2 reaches the threshold voltage Vth2 of the inverter IN3, the output voltage of the inverter IN3 makes a low-to-high transition (Fig.9(10)). The inverter IN3 then outputs a high level voltage to the AND circuit AND1. When the high level voltage is input from the inverter IN3, the AND circuit AND1 makes the TXD signal pass through as it is, and drives the input signal to the base terminal of the NPN bipolar transistor TR1 high (Fig.9(11)).

When the input signal to the base terminal of the NPN bipolar transistor TR1 is driven high, the electric current IL1 begins to flow into the light emitting diode LED1 (Fig.9(12)). The light emitting diode LED1 begins to emit light again.

Part of the infrared ray output from the light emitting diode LED1 is input to the photodiode PD1, and the photoelectric current IP flows into the photodiode PD1 (Fig.9(13)). The photoelectric current IP flows into the RC circuit composed of the resistor R2 and the capacitor C1, and an electric charge is stored in the capacitor C1. The electric charge stored in the capacitor C1 raises the voltage VC1 of the capacitor C1 (Fig.9(14)).

When the voltage VC1 reaches the threshold voltage Vth1 of the inverter IN1, the output voltage of the inverter IN1 makes a high-to-low transition (Fig.9(15)). The inverter IN1 then outputs a low level voltage to the inverter IN2. When the low level voltage is input from the inverter IN1, the output voltage of the inverter IN2 makes a low-to-high transition, and the inverter IN2 outputs a high level voltage to the capacitor C2.

As a result, an electric current determined according to the capacity of the capacitor C2 and the output impedance of the inverter IN2 flows into the capacitor C2, and the voltage VC2 of the capacitor C2 rises. (Fig.9(16)).

When the voltage VC2 of the capacitor C2 rises and reaches the threshold voltage Vth2 of the inverter IN3, the output voltage of the inverter IN3 makes a high-to-low transition (Fig.9(17)). The inverter IN3 then outputs a low level voltage to the AND circuit AND1.

When the low level voltage is input from the inverter IN3, the AND circuit AND1 prevents the TXD signal from entering the base terminal of the NPN bipolar transistor TR1, and drives the input signal to the base terminal of the NPN bipolar transistor TR1 low (Fig.9 (18)). Accordingly, the electric current IL1 does not flow into the light emitting diode LED1, and the light emitting diode stops emitting light.

The light emitting diode LED1 is then switched between ON and OFF until the reset period terminates, so as to protect the light emitting diode LED1 from being destroyed due to an overcurrent.

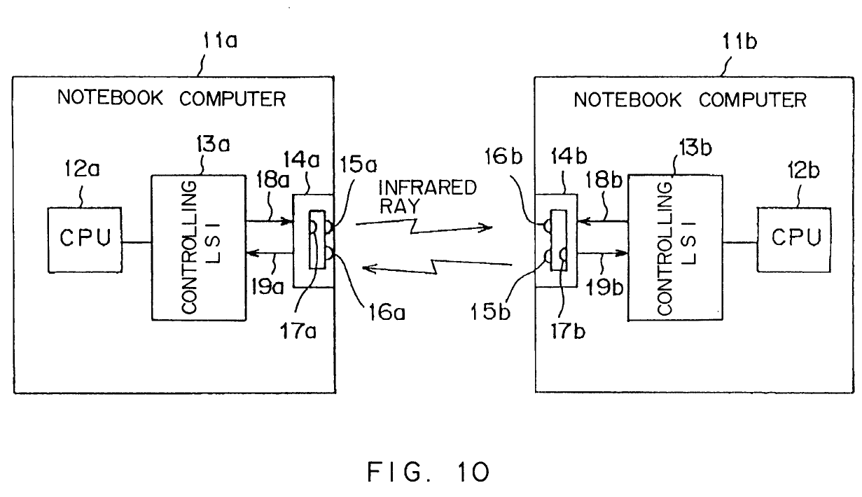

Fig.10 is a schematic diagram showing the example in which a light emitting element protecting device according to an embodiment of the present invention is applied to an optical communication performed by a notebook computer.

In this figure, 11a and 11b indicate notebook computers; 12a and 12b indicate CPUs which control the notebook computers 11a and 11b; 13a and 13b indicate control LSIs which control infrared ray units 14a and 14b; 14a and 14b indicate the infrared ray units which make optical communications between the respective notebook computers 11a and 11b and themselves; 15a and 15b indicate light emitting elements; 16a and 16b indicate light receiving elements which detect light from the other light emitting elements 15b and 15a; and 17a and 17b indicate light receiving elements which detect light from their own light emitting element 15a and 15b, respectively.

The controlling LSIs 13a and 13b are controlled by the CPUs 12a and 12b. When TXD signals 18a and 18b are transmitted from the controlling LSIs 13a and 13b to the infrared ray units 14a and 14b, the infrared ray units 14a and 14b output infrared rays from the light emitting elements 15a and 15b. The infrared rays from the light emitting elements 15a and 15b are detected by the light receiving elements 16b and 16a, and the infrared ray units 14a and 14b respectively output RXD (reception transmission data) signals 19a and 19b to the controlling LSIs 13a and 13b.

During the reset period, the switching period of the controlling LSIs when the power supply is ON, the TXD signals transmitted from the controlling LSIs 13b and 13a to the infrared ray units 14a and 14b are driven high, and an electric current of approximately 50mA flows into the light emitting elements 15a and 15b.

The infrared ray units 14a and 14b monitor the infrared rays output from the light emitting elements 15a and 15b using the light receiving elements 17a and 17b at this time. If the light emitting elements 15a and 15b continue to emit light for a predetermined amount of time or more, the infrared ray units 14a and 14b stop the light emitting elements 15a and 15b from emitting light by shutting off the electric currents flowing into the light emitting elements 15a and 15b. As a result, the light emitting elements 15a and 15b are protected.

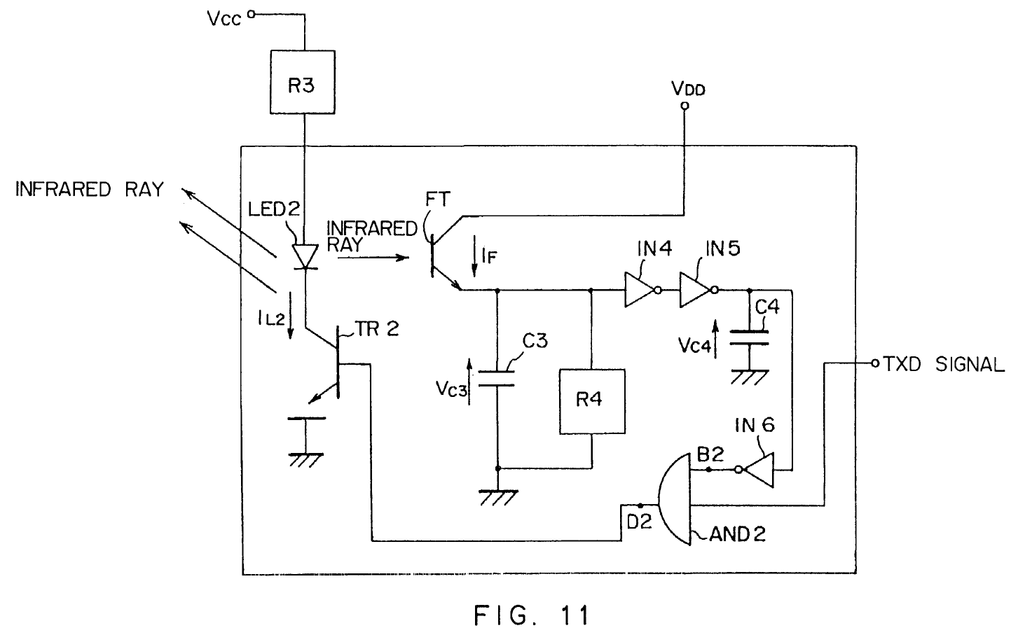

Fig.11 is a schematic diagram showing the configuration of a light emitting element protecting device according to a third embodiment of the present invention. The embodiment shown in Fig.11 employs a photo-transistor FT instead of the photodiode PD1 in the embodiment shown in Fig.7.

In Fig.11, VCC indicates a power supply, and its value is normally set to 5V; R3 and R4 indicate resistors, and their values are respectively set to several ohms and approximate 5K ohms; C3 and C4 indicate capacitors, and their values are respectively and approximately set to 40nF and 2ΦF; LED2 indicates a light emitting diode; TR2 indicates an NPN bipolar transistor which drives the light emitting diode LED2; FT indicates a photodiode which detects an infrared ray from the light emitting diode LED2; IN4, IN5 and IN6 indicate inverters; and AND2 indicates an AND circuit.

A collector terminal of the NPN bipolar transistor TR2 is connected with a cathode terminal of the light emitting diode LED2. A base terminal of the NPN bipolar transistor TR2 is connected with an output terminal of the AND circuit AND2. An emitter terminal of the NPN bipolar transistor TR2 is connected to a ground. An anode terminal of the light emitting diode LED2 is connected to the power supply voltage VCC via the resistor R3.

The resistor R4 and the capacitor C3 are connected in parallel to configure an RC circuit. One end of the RC circuit is connected with an emitter terminal of the photo-transistor FT and an input terminal of the inverter IN4. The other end of the RC circuit is connected with ground, and a collector terminal of the photo-transistor FT is connected to the power supply voltage VDD.

Inverters IN4, IN5, and IN6 are connected in series, and the grounded capacitor C4 is connected between the inverters IN5 and IN6. A first input terminal of the AND circuit AND2 is connected with an output terminal of the inverter IN6. A second input terminal of the AND circuit AND 2 is connected with an input terminal of the TXD signal.

Since the light emitting diode LED 2 does not emit light until the TXD signal is input to the AND circuit AND2, a photoelectric current IF does not flow into the photo-transistor FT. Accordingly, the voltage VC3 of the capacitor C3 is "0", and also the voltage VC4 of the capacitor C4 remains "0". Because the level of the voltage VC4 of the capacitor C4 is inverted by the inverter IN6, the electric potential of the first input terminal of the AND circuit AND 2 at a point B2 is driven high.

When the TXD signal is input to the AND circuit AND2 in this state, the signal passes through the AND circuit AND2 unchanged, and the electric potential of the output terminal of the AND circuit AND2 at a point D2 will become the value corresponding to the TXD signal.

As a result, the TXD signal which passed through the AND circuit AND2 is input to the base terminal of the NPN bipolar transistor TR2 unchanged. When the TXD signal is driven high, the NPN bipolar transistor TR2 will be turned on. Accordingly, the electric current IL2 of approximately 300mA-450mA flows into the light emitting diode LED2, and an infrared ray is output from the light emitting diode LED2.

Part of the infrared ray output from the light emitting diode LED2 is input to the photo-transistor FT, and the photoelectric current IF flows into the photo-transistor FT. The photoelectric current IF flows into the RC circuit composed of the resistor R4 and the capacitor C3, and an electric charge is stored in the capacitor C3. The electric charge stored in the capacitor C3 generates the voltage VC3 in the capacitor C3, and this voltage is input to the inverter IN4.

When the infrared ray is output from the light emitting diode LED2 for a predetermined amount of time or more, and the voltage VC3 reaches a threshold voltage Vth3 of the inverter IN4, the inverter IN4 outputs a low level voltage to the inverter IN5. When the low level voltage is input from the inverter IN4, the inverter IN5 outputs a high level voltage to the capacitor C4. As a result, an electric current determined according to the capacity of the capacitor C4 and the output impedance of the inverter IN5 flows into the capacitor C4, and an electric charge is stored in the capacitor C4. The electric charge stored in the capacitor C4 generates the voltage VC4 in the capacitor C4. The voltage VC4 is then input to the inverter IN6.

When the voltage VC4 reaches a threshold voltage Vth4 of the inverter IN6, the inverter IN6 outputs a low level voltage to the AND circuit AND2. When the low level voltage is input from the inverter IN6, the AND circuit AND2 prevents the TXD signal from passing through the circuit itself.

When the TXD signal is stopped by the AND circuit AND2 and is not transmitted to the base terminal of the NPN bipolar transistor TR2, the input signal to the base terminal of the NPN bipolar transistor TR2 will be driven low. As a result, the electric current IL2 does not flow into the light emitting diode LED2, and the light emitting diode LED2 stops emitting light.

Similarly, the emission of the light emitting diode LED2 is switched between ON and OFF while the TXD signal remains high, thereby protecting the light emitting diode LED2 from being destroyed due to an overcurrent.

The truth table indicating the operations of the light emitting element protecting device shown in Fig.11 is similar to that shown in Fig.8. That is, if the logical value of the TXD signal is "1", the potential level at the point B2 becomes a pulse form. Accordingly, also the electric potential at the point D2 becomes a pulse form, and the light emitting diode LED2 is switched between ON and OFF. If the logical value of the TXD signal is "0", the logical values at the points B2 and D2 will respectively become "1" and "0". The light emitting diode LED2 is therefore turned off.

The embodiment shown in Fig.7 refers to the case in which the light detecting element is implemented by the photodiode PD1, while the embodiment shown in Fig.11 refers to the case in which the light detecting element is implemented by the photo-transistor FT. However, the light detecting element may also be implemented by an avalanche photodiode. Use of an avalanche photodiode as the light detecting element allows high-speed light detection.

Additionally, the light detecting element may be implemented by a photoconductor such as a CdS cell, CdSe cell, PbS cell, etc. Since the response speed of a photoconductor is low, it can effectively detect a direct current component which destroys a light emitting diode without badly affecting data to be transmitted at a high bit rate.

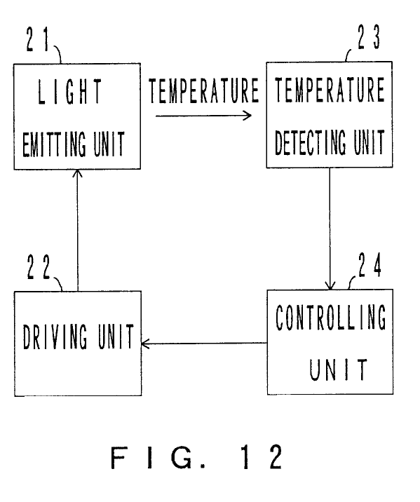

Fig.12 is a block diagram showing the configuration of a light emitting diode protecting device according to the fourth embodiment of the present invention. According to this embodiment, the temperature of a light emitting unit 21 is detected, so that this unit is protected from being destroyed due to an overcurrent.

In Fig.12, the light emitting unit 21 emits light based on a driving input; a driving unit 22 drives the light emitting unit 21 by providing a driving input to the light emitting unit 21; a temperature detecting unit 23 detects the temperature of the light emitting unit 21; a controlling unit 24 controls the driving unit 22 based on a detection signal from the temperature detecting unit 23.

For example, if the temperature of the light emitting unit 21, which is detected by the temperature detecting unit 23, is equal to or higher than a predetermined value, the controlling unit 24 may be implemented so as to stop the driving unit 22 from driving the light emitting unit 21.

When the driving unit 22 drives the light emitting unit 21 and light is output from the light emitting unit 21 for a predetermined amount of time or more, the temperature of the light emitting unit 21 rises beyond the temperature range of normal operations. The temperature detecting unit 23 detects the temperature of the light emitting unit 21, and its detection signal is transmitted to the controlling unit 24. The controlling unit 24 monitors the temperature of the light emitting unit 21 based on the detection signal transmitted from the temperature detecting unit 23. When the temperature of the light emitting unit 21 exceeds a predetermined value, the controlling unit 24 stops the driving unit 22 from driving the light emitting unit 21. As a result, the light emitting unit 21 is protected from being destroyed due to an overcurrent.

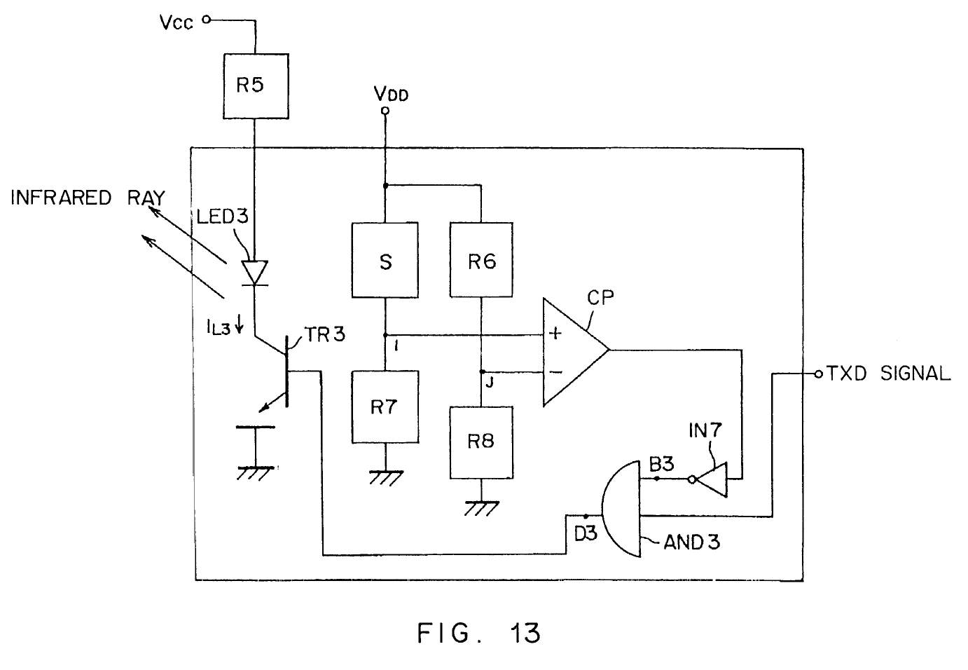

Fig.13 is a schematic diagram showing the configuration of a light emitting element protecting device according to the fifth embodiment of the present invention. According to this embodiment, whether or not the voltage value of a thermistor reaches a predetermined value is determined by a comparator, so that whether or not an overcurrent flows into a light emitting diode is determined.

In Fig.13, VCC indicates a power supply voltage, and its value is normally set to 5V. R5, R6, R7, and R8 indicate resistors; the value of the resistor R5 is normally set to several ohms; and the values of the resistors R6, R7, and R8 are set so that the ratio of the resistance value of the thermistor S to that of the resistor R7 at the temperature where a light emitting diode LED3 normally operates is larger than the ratio of the resistance value of the resistor R6 to that of the resistor R8, and the ratio of the resistance value of the thermistor S to that of the resistor R7 at the temperature where the light emitting diode LED3 is destroyed is smaller than the ratio of the resistance value of the resistor R6 to that of the resistor R8.

LED3 indicates a light emitting diode; TR3 indicates an NPN bipolar transistor which drives the light emitting diode LED3; S indicates the thermistor which detects the temperature of the light emitting diode LED3; CP indicates a comparator. IN7 indicates an inverter; and AND3 indicates an AND circuit.

A collector terminal of the NPN bipolar transistor TR3 is connected with a cathode terminal of the light emitting diode LED3. A base terminal of the NPN bipolar transistor TR3 is connected with an output terminal of the AND circuit AND3. An emitter terminal of the NPN bipolar transistor TR3 is connected to ground. An anode terminal of the light emitting diode LED3 is connected with the power supply voltage VCC via the resistor R5.

The thermistor S and the resistor R7 are connected in series, and a first input terminal of the comparator CP is connected in between. The other terminal of the thermistor S is connected to a power supply voltage VDD, and the other terminal of the resistor R7 is grounded.

The resistors R6 and R8 are connected in series, and a second input terminal of the comparator CP is connected in between. The other terminal of the resistor R6 is connected to the power supply voltage VDD, and the other terminal of the resistor R8 is grounded.

An output terminal of the comparator CP is connected with an input terminal of the inverter IN7. A first input terminal of the AND circuit AND3 is connected with an output terminal of the inverter IN7. A second input terminal of the AND circuit AND3 is connected with an input terminal of the TXD signal.

Since the electric current IL3 does not flow into the light emitting diode LED3 until the TXD signal is input to the AND circuit AND3, the light emitting diode LED3 stays at room temperature. Accordingly, the resistance value of the thermistor S becomes larger, lower, and the electric potential at a point I is lower than that at a point J. As a result, a low level signal is output from the comparator CP. After the low level signal output from the comparator CP is inverted and driven high by the inverter IN7, it is input to the first input terminal of the AND circuit AND3.

When the TXD signal is input to the AND circuit AND3 in this state, it passes through the AND circuit AND3 unchanged. The electric potential of the output terminal of the AND circuit AND3 at the point D3 will become a value corresponding to the TXD signal.

As a result, the TXD signal which passed through the AND circuit AND 3 is input to the base terminal of the NPN bipolar transistor TR3 unchanged. When the TXD signal is driven high, the NPN bipolar transistor TR3 is turned on. As a result, the electric current IL3 of approximately 300mA-450mA flows into the light emitting diode LED3, and an infrared ray is output from the light emitting diode LED3.

When the electric current IL3 of approximately 300mA-450mA flows into the light emitting diode LED3, the temperature of the light emitting diode LED3 rises. As the temperature of the light emitting diode LED3 rises, the resistance value of the thermistor S becomes larger. If the electric potential at the point I becomes lower than that at the point J, an output signal from the comparator CP makes a low-to-high transition. The high level signal output from the comparator CP is inverted and driven low by the inverter IN7, and input to the first input terminal of the AND circuit AND3.

When the low level voltage is input from the inverter IN7, the AND circuit AND3 prevents the TXD signal from passing through the AND circuit AND3.

When the TXD signal is stopped by the AND circuit AND3 and is not transmitted to the base terminal of the NPN bipolar transistor TR3, an input signal to the base terminal of the NPN bipolar transistor TR3 is driven low. As a result, the electric current IL3 does not flow into the light emitting diode LED3, and the light emitting diode LED3 stops emitting light.

When the electric current IL3 does not flow into the light emitting diode LED3, the temperature of the light emitting diode LED3 drops. As the temperature of the light emitting diode LED3 drops, the resistance value of the thermistor S becomes larger. Accordingly, the electric potential at the point I drops and becomes lower than that at the point J, and the output signal from the comparator CP makes a high-to-low transition. The low level signal output from the comparator CP is inverted and driven high by the inverter IN7, and input to the first input terminal of the AND circuit AND3.

As a result, the TXD signal which passed through the AND circuit AND3 is input to the base terminal of the NPN bipolar transistor TR3 as it is. When the TXD signal is driven high, the NPN bipolar transistor TR3 is turned on. As a result, the electric current IL3 of approximately 300mA-450mA flows into the light emitting diode LED3, and an infrared ray is output from the light emitting diode LED3.

Similarly, the electric current IL3 flowing into the light emitting diode LED3 is switched between ON and OFF while the TXD signal goes high. The light emitting diode LED3 is therefore protected from being destroyed due to an overcurrent.

The truth table indicating the operations of the light emitting element protecting device shown in Fig.13 is similar to that shown in Fig.8. That is, if the logical value of the TXD signal is "1", the electric potential level at the point B3 will become a pulse form. Accordingly, also the electric potential level at the point D3 will become a pulse form, and the light emitting diode LED3 is switched between ON and OFF. If the logical value of the TXD signal is "0", the logical values at the points B3 and D3 will respectively become "1" and "0". As a result, the light emitting diode LED3 is turned off.

Note that the temperature of the light emitting diode LED3 can be detected by the thermistor S, which is attached to the light emitting diode LED3 with an epoxy resin, by heat conduction from the light emitting diode LED3. Furthermore, the temperature of the light emitting diode LED 3 may be detected by inputting light output from the light emitting diode LED3 to the thermistor S, and using a rise in the temperature of the thermistor S, which is caused by the light output from the light emitting diode LED3.

The embodiment shown in Fig.13 refers to the case in which the temperature detecting element is implemented by the thermistor S. However, the temperature detecting element may also be implemented by a thermocouple. The temperature measurement range can be enlarged by using a thermocouple as the temperature detecting element.

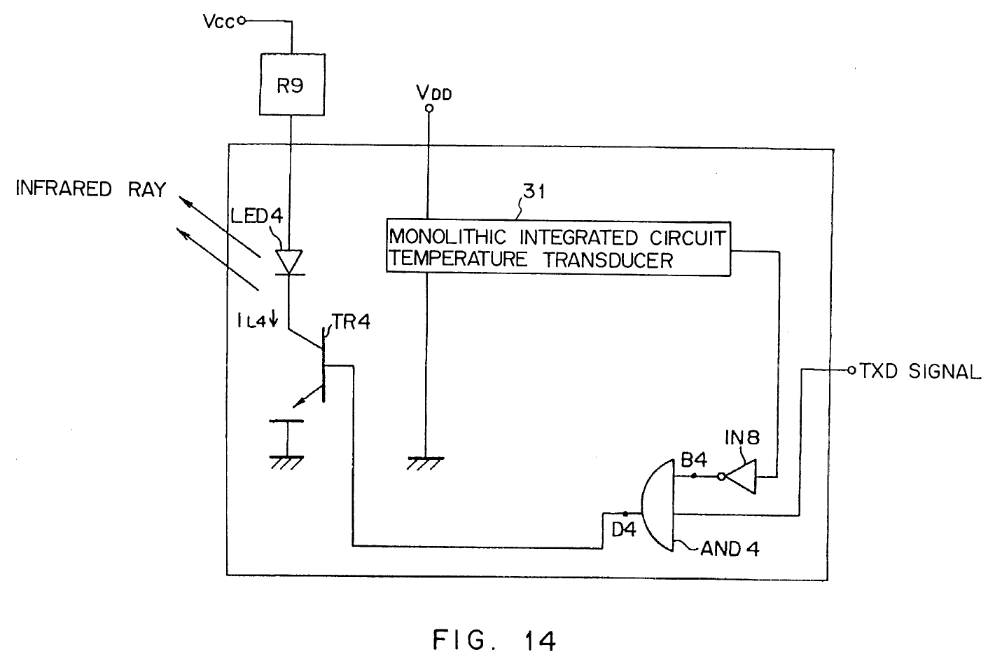

Fig.14 is a schematic diagram showing the configuration of a light emitting element protecting device according to the sixth embodiment of the present invention. According to this embodiment, whether or not an overcurrent flows into a light emitting diode is determined based on the output value from a monolithic integrated circuit temperature transducer.

In Fig.14, VCC indicates a power supply voltage, and its value is normally set to 5V; R9 indicates a resistor, and its value is normally set to several ohms; LED4 indicates a light emitting diode; TR4 indicates an NPN bipolar transistor which drives the light emitting diode LED4; 31 indicates a monolithic integrated circuit temperature transducer which detects the temperature of the light emitting diode LED4; IN8 indicates an inverter; and AND4 indicates an AND circuit.

The monolithic integrated circuit temperature transducer 31 is implemented by applying the phenomenon in which a forward threshold voltage in a P-N junction changes almost linearly according to a temperature change. Various signal circuits and temperature transducers are integrated, and the temperature can be detected with almost no external circuit operation.

As the monolithic integrated circuit temperature transducer 31, an LM35 provided by National Semiconductor, AD590 and AD594 provided by Analog Devices, ICL8073 and ICL8074 provided by Intercil, etc. are available.

Here, a collector terminal of the NPN bipolar transistor TR4 is connected with a cathode terminal of the light emitting diode LED4. A base terminal of the NPN bipolar transistor TR4 is connected with an output terminal of the AND circuit AND4. An emitter terminal of the NPN bipolar transistor TR4 is connected to ground. An anode terminal of the light emitting diode LED4 is connected to the power supply voltage VCC via the resistor R9.

The monolithic integrated circuit temperature transducer 31 is connected to a power supply voltage VDD and ground. An output terminal of the monolithic integrated circuit temperature transducer 31 is connected with an input terminal of the inverter IN8. A first input terminal of the AND circuit AND4 is connected with an output terminal of the inverter IN8. A second input terminal of the AND circuit AND4 is connected with an input terminal of the TXD signal.

Since an electric current IL4 does not flow into a light emitting diode LED4 until the TXD signal is input to the AND circuit AND4, the light emitting diode LED4 stays at room temperature. Accordingly, the output value from the monolithic integrated circuit temperature transducer 31 is driven low. The low level signal output from the monolithic integrated circuit temperature transducer 31 is inverted and driven high by the inverter IN8, and input to the first input terminal of the AND circuit AND4.

When the TXD signal is input to the AND circuit AND4 in this state, it passes through the AND circuit AND4 as it is, and the electric potential of the output terminal of the AND circuit AND4 at a point D4 will become a value corresponding to the TXD signal.

As a result, the TXD signal which passed through the AND circuit AND4 is input to the base terminal of the NPN bipolar transistor TR4. When the TXD signal is driven high, the NPN bipolar transistor TR4 is turned on. The electric current IL4 of approximately 300mA-450mA therefore flows into the light emitting diode LED4, and an infrared ray is output from the light emitting diode LED4.

When the electric current IL4 of approximately 300mA-450mA flows into the light emitting diode LED4, the temperature of the light emitting diode LED4 rises. As the temperature of the light emitting diode LED4 rises, the output value from the monolithic integrated circuit temperature transducer 31 becomes higher. The high level signal output from the monolithic integrated circuit temperature transducer 31 is inverted and driven low by the inverter IN8, and input to the first input terminal of the AND circuit AND4.

When the low level voltage is input from the inverter IN8, the AND circuit AND4 prevents the TXD signal from passing through the AND circuit AND8.

When the TXD signal is stopped by the AND circuit AND4, and is not transmitted to the base terminal of the NPN bipolar transistor TR4, the input signal to the base terminal of the NPN bipolar transistor TR4 is driven low. As a result, the electric current IL4 does not flow into the light emitting diode LED4, and the light emitting diode LED4 stops emitting light.

When the electric current IL4 does not flow into the light emitting diode LED4, the temperature of the light emitting diode LED4 drops. As the temperature of the light emitting diode LED4 drops, the output value from the monolithic integrated circuit temperature transducer 31 becomes lower. The low level signal output from the monolithic integrated circuit temperature transducer 31 is inverted and driven high by the inverter IN8, and input to the first input terminal of the AND circuit AND4.

As a result, the TXD signal which passed through the AND circuit AND4 is input to the base terminal of the NPN bipolar transistor TR4. When the TXD signal is driven high, the NPN bipolar transistor TR4 is turned on. Accordingly, the electric current IL4 of approximately 300mA-450mA flows into the light emitting diode LED4, and an infrared ray is output from the light emitting diode LED4.

Similarly, while TXD signal remains high, the electric current IL4 flowing into the light emitting diode LED4 is switched between ON and OFF. Therefore, the light emitting diode LED4 can be protected from being destroyed due to an overcurrent.

If the monolithic integrated circuit temperature transducer 31 is used as the temperature detecting unit of the light emitting diode LED4, the circuit configuration can be simplified. Since the monolithic integrated circuit temperature transducer 31 detects the temperature according to a change of a forward energy gap of a P-N junction, it can be easily integrated with the NPN bipolar transistor TR4, light emitting diode LED4, inverter IN8, AND circuit AND4, etc. As a result, the size and weight of the protecting device for the light emitting diode LED4 can be reduced, and at the same time, its mass-productivity can be improved.

The truth table indicating the operations of the light emitting element protecting device shown in Fig.14 is similar to that shown in Fig.8. That is, if the logical value of the TXD signal is "1", the electric potential level at the point B4 will become a pulse form. Accordingly, also the electric potential level at the point D4 will become a pulse form, and the light emitting diode LED4 is switched between ON and OFF. If the logical value of the TXD signal is "0", the logical values at the points B4 and D4 will respectively become "1" and "0", and the light emitting diode LED 4 is turned off.

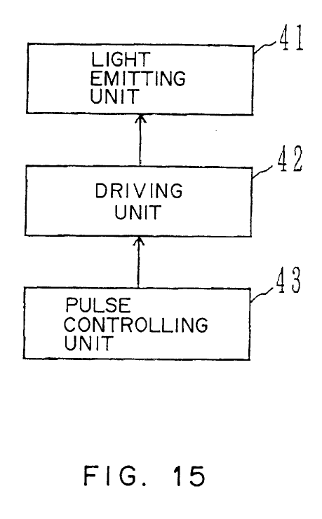

Fig.15 is a block diagram showing the configuration of a light emitting element protecting device according to the seventh embodiment of the present invention.

In this figure, a light emitting unit 41 emits light based on a driving input; a driving unit 42 drives the light emitting unit 41; a pulse controlling unit 43 passes an input signal having a predetermined pulse width through as it is, converts an input signal having a pulse width wider than the predetermined width into the signal having the redetermined pulse width, and provides it to the driving unit 42.

With this process, if an input signal to the driving unit 42 is transmission data with the predetermined pulse width, it is optically transmitted unchanged from the light emitting unit 41. If an input signal to the driving unit 42 is a direct current signal, it is converted into a pulse signal having a predetermined pulse width, and provided to the driving unit 42. Accordingly, continuous light emission by the light emitting unit 41 is prevented, thereby protecting the light emitting unit 41 from being destroyed due to a high level direct current signal.

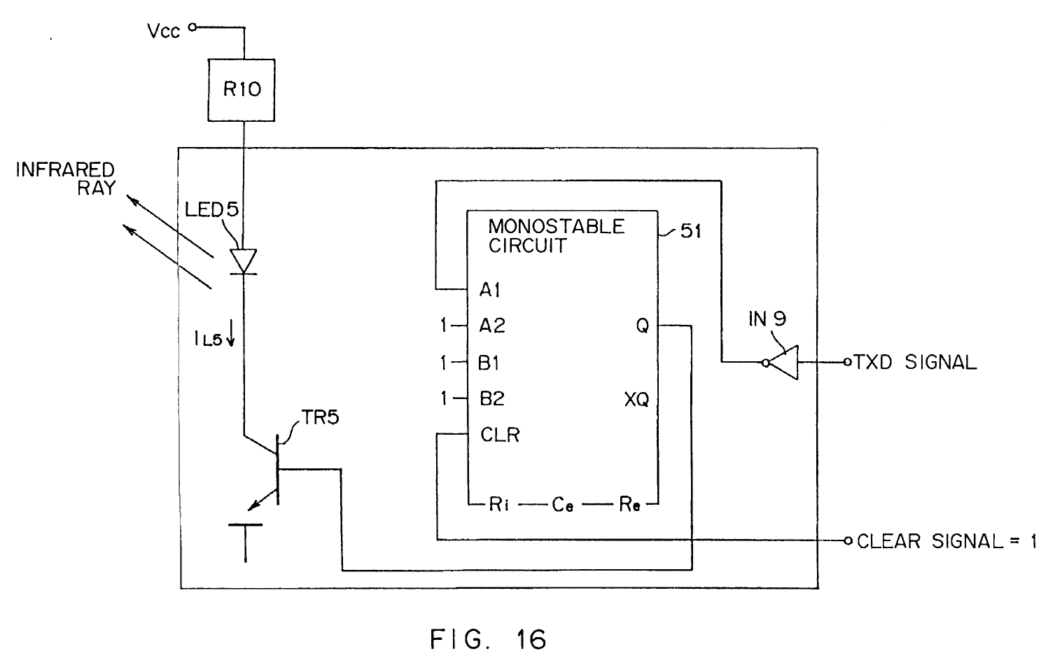

Fig.16 is a schematic diagram showing the configuration of a light emitting element protecting device according to the eighth embodiment of the present invention. According to this embodiment, a pulse width of an input signal is converted by using a monostable circuit.

In Fig.16, VCC indicates a power supply voltage, and its value is normally set to 5V; R10 indicates a resistor, and its value is normally set to several ohms; LED5 indicates a light emitting diode; TR5 indicates an NPN bipolar transistor which drives the light emitting diode LED5; 51 indicates a monostable circuit which converts a pulse width of an input signal; and IN9 indicates an inverter.

In the monostable circuit 51, A1, A2, B1, and B2 are input terminals; CLR indicates a clear terminal; Q indicates an output terminal; XQ indicates an inverted output terminal; Ri indicates an external timing resistance terminal; Ce indicates an external capacity terminal; and Re indicates an external capacity/external resistance terminal.

As the monostable circuit 51, for example, devices SN54122, SN74122, SN54LS122, SN74LS122 provided by Texas Instruments, etc. are available.

A collector terminal of the NPN bipolar transistor TR5 is connected with a cathode terminal of the light emitting diode LED5. A base terminal of the NPN bipolar transistor TR5 is connected with the output terminal Q of the monostable circuit 51. An emitter terminal of the NPN bipolar transistor TR5 is connected to ground. An anode terminal of the light emitting diode LED5 is connected to the power supply voltage VCC via the resistor R10. The input terminal A1 of the monostable circuit 51 is connected with an input terminal of the TXD signal via the inverter IN9.

The clear terminal CLR of the monostable circuit 51 is connected with a clear terminal of a reset IC. A clear signal from the reset IC is input to the clear terminal CLR of the monostable circuit 51, and the logical value "1" is input to the input terminals A2, B1, and B2.

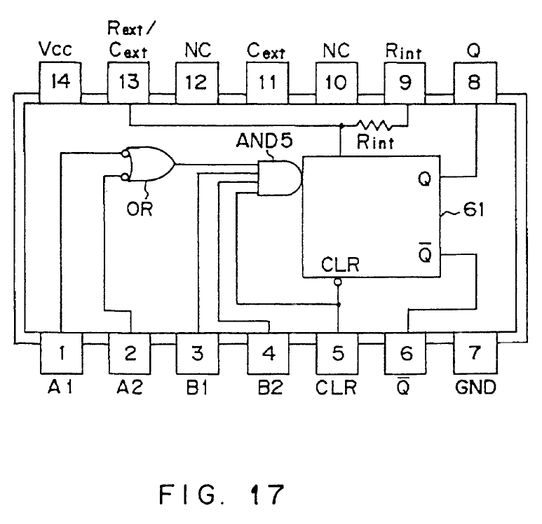

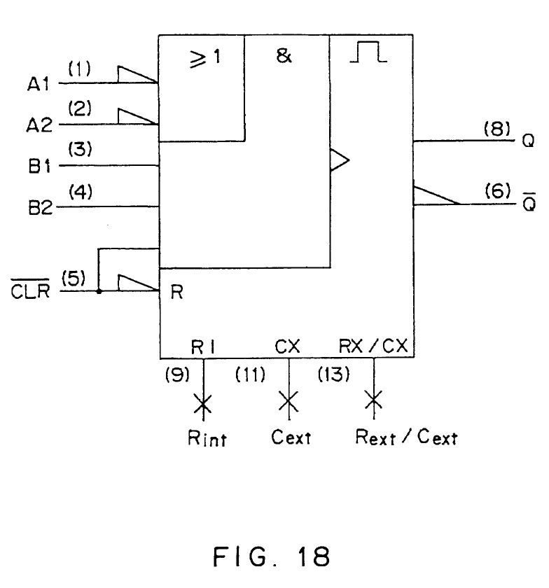

Fig.17 is a simplified schematic diagram showing the configuration of the monostable circuit 51 shown in Fig.16. Fig.18 shows the logical symbols representing the monostable circuit 51 shown in Fig.17.

In Fig.17, 1 indicates an A1 terminal; 2 indicates an A2 terminal; 3 indicates a B1 terminal; 4 indicates a B2 terminal; 5 indicates a CLR terminal; 6 indicates a inverted output terminal; 7 indicates a GND terminal; 8 indicates a non-inverted output terminal; 9 indicates a Rint terminal; 10 indicates an NC terminal; 11 indicates a Cext terminal; 12 indicates an NC terminal; 13 indicates an Rext/Cest terminal; and 14 indicates a VCC terminal.

OR indicates a two-input OR circuit equipped with a logical NOT element; AND5 indicates a five-input AND circuit; 61 indicates a multi-vibrator equipped with a clear terminal; and Rint indicates an external timing resistor.

The A1 terminal 1 is connected with a first input terminal of the OR circuit OR. The A2 terminal 2 is connected with a second input terminal of the OR circuit OR. The B1 terminal 3 is connected with a second input terminal of the AND circuit AND5. The B2 terminal 4 is connected with a third input terminal of the AND circuit AND5. The CLR terminal 5 is connected with a fourth input terminal of the AND circuit AND5 and the clear terminal CLR of the multi-vibrator 61. The inverted output terminal 6 is connected with a inverted output terminal of the multi-vibrator 61. The non-inverted output terminal 8 is connected with a non-inverted output terminal of the multi-vibrator 61. The external timing resistance Rint is connected between the Rint terminal 9 and the Rext/Cext terminal 13.

The output terminal of the OR circuit OR is connected with a first input terminal of the AND circuit AND5, and an output terminal of the AND circuit AND5 is connected with an input terminal of the multi-vibrator 61.

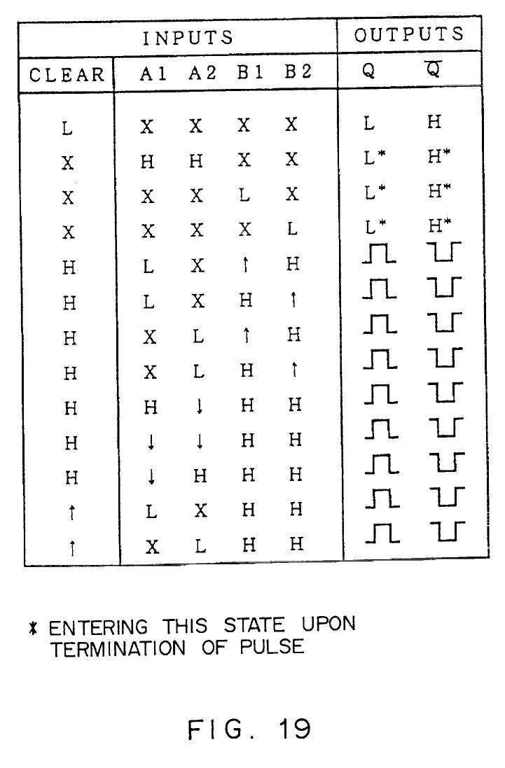

Fig.19 is a functional table indicating the operations of the monostable circuit shown in Fig.17.

Assume that the A2 terminal 2, B1 terminal 3, B2 terminal 4, and the CLR terminal 5 are set to an "H" level, and a trigger pulse is input to the A1 terminal in this figure. At this time, a non-inverted output pulse having a pulse width tW is output from the non-inverted output terminal 8, and an inverted output pulse having the pulse width tW is output from the inverted output terminal 6, in correspondence with a negative edge of the trigger pulse input to the A1 terminal.

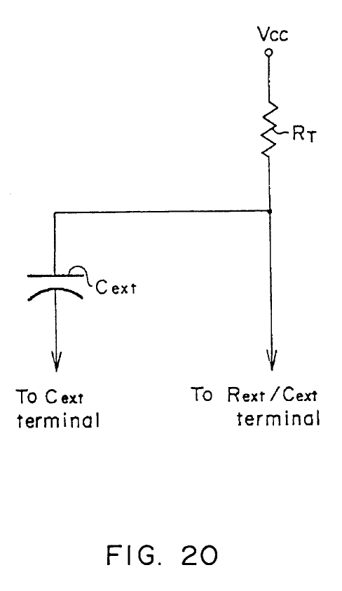

Fig.20 is a circuit diagram showing the configuration of a circuit which is externally attached to the monostable circuit shown in Fig.17.

In this figure, an external resistor RT is connected between a power supply voltage VCC and an Rext/Cext terminal 13. An external capacity Cext is connected between a Cext terminal 11 and the Rext/Cext terminal 13.

At this time, the pulse width tW of a pulse output form the non-inverted output terminal 8 is determined according to the value of the external resistor RT and the value of the external capacitance Cext, and approximated by the following equation.

tW = K ≅ RT ≅ Cext (1 + 0.7 / RT)where K is a constant, the units of the pulse width tW are ns (nanosecond), the units of the external resistor RT are kΣ, and the units of the external capacitance Cext are pF.

Assuming that the value of the external resistor RT is set to 10KΣ and the value of the external capacitance Cext is set to 1000pF, the pulse width tW of a pulse output from the non-inverted output terminal 8 will be 3.42Φs.

Provided next is the explanation about the operations of the light emitting element protecting device shown in Fig.16.

In Fig.16, the levels of the input terminals A1, A2, B1, and B2 are high, and the level of the output value from the positive output terminal Q is low before the TXD signal is input to the monostable circuit 51, and the level of the output value from the non-inverted output terminal Q is low. Accordingly, an input value to the base terminal of the NPN bipolar transistor TR5 is driven low, and the electric current IL5 does not flow into the light emitting diode LED5. As a result, the light emitting diode LED5 stops emitting light.

When the TXD signal is input to the monostable circuit 51 and makes a low-to-high transition in this state, the TXD signal is inverted by the inverter IN9, and the input terminal A1 of the monostable circuit 51 makes a high-to-low transition. A single pulse signal having the pulse width tW is output from the non-inverted output terminal Q of the monostable circuit 51 in correspondence with the negative edge of the input signal provided to the input terminal A1 of the monostable circuit 51.

Accordingly, the input value to the base terminal of the NPN bipolar transistor TR5 is driven high during a period corresponding to the pulse width tW of the pulse signal output from the non-inverted output terminal Q, and the NPN bipolar transistor TR5 is turned on. As a result, the electric current IL5 of approximately 300mA-450mA flows into the light emitting diode LED5, and an infrared ray is output from the light emitting diode LED5 during a period corresponding to the pulse width tW of the pulse signal output from the non-inverted output terminal Q.

Similarly, an infrared ray is output from the light emitting diode LED5 during the period corresponding to the pulse width tW of a pulse signal output from the non-inverted output terminal Q, in correspondence with the positive edge of the TXD signal. Consequently, even if a TXD signal having a wide pulse width, which could destroy the light emitting diode LED5, is input, the diode only emits light during the period corresponding to the pulse width tW of the pulse signal output from the non-inverted output terminal Q of the monostable circuit 51. Therefore, the light emitting diode 5 can be protected from being destroyed due to an overcurrent.

As described above, the light emitting diode LED5 can be protected with simple circuitry by driving the NPN bipolar transistor TR5 using the monostable circuit 51. Additionally, it becomes possible to integrate the monostable circuit 51, NPN bipolar transistor TR5, and the light emitting diode LED5, thereby not only reducing the size and weight of the protecting device for the light emitting diode LED5, but also improving its mass-productivity.

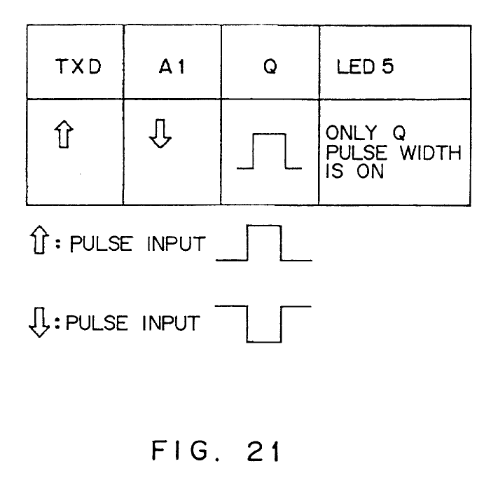

Fig.21 is a truth table indicating the operations of the light emitting element protecting device shown in Fig.16.

In this figure, if a single positive pulse having an arbitrary pulse width is input as the TXD signal, this pulse is inverted by the inverter IN9, and a single negative pulse is input to the input terminal A1 of the monostable circuit 51. As a result, a single pulse signal having a pulse width tW is output from the non-inverted output terminal Q of the monostable circuit 51, and the light emitting diode LED5 is turned on during a period corresponding to the pulse width tW of a pulse signal output from the non-inverted output terminal Q.

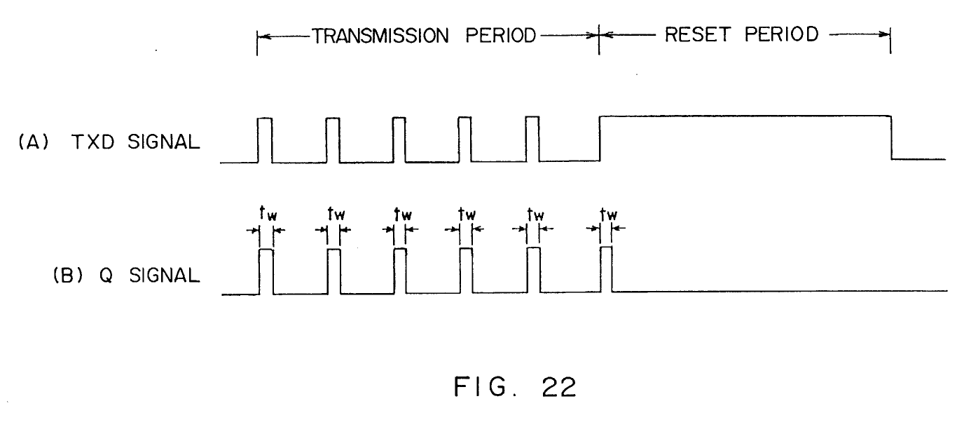

Fig.22 is a timing chart showing the operations of the light emitting element protecting device shown in Fig.16.

As shown in Fig.22(A), the TXD signal during the transmission period is a pulse signal. A pulse signal having a pulse width tW is output from the non-inverted output terminal Q of the monostable circuit 51 in correspondence with the positive edge of the TXD signal, as shown in Fig.22(B). Here, the pulse width tW of the pulse signal output from the non-inverted output terminal Q of the monostable circuit 51 is set to, for example, the pulse width of the TXD signal during the transmission period, so that the TXD signal during the transmission period is provided to the base terminal of the NPN bipolar transistor TR5 as it is. As a result, the electric current IL5 flows into the light emitting diode LED5 in a pulse like manner, and the light emitting diode LED5 performs pulse-light-emission.

When the transmission period changes to the reset period, the TXD signal is driven high, and a high level clear signal is input from the reset IC to the clear terminal CLR of the monostable circuit 51. At this time, a single pulse signal having the pulse width tW is output in correspondence with the positive edge of the TXD signal. Accordingly, the NPN bipolar transistor TR5 is turned on during the period corresponding to the pulse width tW of a pulse signal output from the monostable circuit 51. As a result, the light emitting diode LED51 emits light during the period corresponding to the pulse width tW of the pulse signal output from the monostable circuit 51, thereby protecting the light emitting diode LED5 from being destroyed due to an overcurrent.

Claims

1. A light emitting element protecting device, comprising:
a converter to convert a driving signal having an arbitrary pulse width into a driving input having a predetermined pulse width;
light emitting means for emitting light based on the driving input;
light detecting means for detecting light output from said light emitting means and producing a signal identifying when light is output;
light duration measuring means for receiving the signal from the light detecting means and measuring the length of time light is output from said light emitting means; and
controlling means for controlling said driving input based on the length of time light is output from said light emitting means, so as to prevent said light emitting means from being damaged.

2. A light emitting element protecting device, comprising:
a converter to convert a driving signal having an arbitrary pulse width into a driving input having a predetermined pulse width;
light emitting means for emitting light based on the driving input;
light detecting means for detecting light output from said light emitting means and producing a signal identifying when light is output;
light duration measuring means for receiving the signal from the light detecting means and measuring the length of time light is output from said light emitting means; and
controlling means for controlling said driving input based on the length of time light is output from said light emitting means, so as to prevent said light emitting means from being damaged, wherein
said light duration means comprises integrating means for integrating the detection signal from said light detecting means, and
said controlling means comprises:
determining means for determining whether or not an integration result by said integrating means reaches a predetermined value; and
canceling means for canceling a driving operation of said light emitting means, which is performed by said driving input, based on a result of determination made by said determining means.

3. A light emitting element protecting device, comprising:
a light emitting diode;
a transistor for driving the light emitting diode;
a photodiode for detecting light output from said light emitting diode;
a differential circuit for integrating a photoelectric current from said photodiode; and
a preventing circuit preventing said transistor from driving said light emitting diode after a predetermined period of time has elapsed from when a value integrated by said differential circuit reaches a predetermined value, so as to prevent said light emitting diode from being damaged.

4. A light emitting element protecting device, comprising:
a light emitting diode;
a transistor for driving the light emitting diode;
a photo-transistor for detecting light output from said light emitting diode;
a differential circuit for integrating a photoelectric current from said photo-transistor; and
a preventing circuit preventing said transistor from driving said light emitting diode after a predetermined period of time has elapsed from when a value integrated by said differential circuit reaches a predetermined value, so as to prevent said light emitting diode from being damaged.

5. The light emitting element protecting device according to claim 3, wherein said preventing circuit comprises:
a first inverter to which the value integrated by said differential circuit is input;
a second inverter to which an output value from said first inverter is input;
a capacitor for integrating an output value from said second inverter;
a third inverter to which a voltage value of said capacitor is input; and
an AND circuit for outputting to said transistor an ANDed result of a transmission instructing signal and an output value from said third inverter.

6. A light emitting element protecting device, comprising:
light emitting means for emitting light based on a driving input;
driving means for driving said light emitting means;
temperature detecting means for detecting a temperature of said light emitting means;
driving input duration measuring means for measuring the length of time said driving input is applied to said light emitting means; and
controlling means for controlling said driving means based on a detection signal from said temperature detecting means and on a predetermined length of time as detected by said driving input duration measuring means, so as to prevent said light emitting means from being damaged.

7. A light emitting element protecting device comprising:
a light emitting diode;
a transistor for driving said light emitting diode;
a thermistor for detecting a temperature of said light emitting diode;
a comparator for determining whether or not a voltage value of said thermistor reaches a predetermined value;
an inverter for inverting an output value from said comparator; and
an AND circuit for outputting to said transistor an ANDed result of a transmission instructing signal and an output value from said inverter, so as to prevent said light emitting diode from being damaged.

8. A light emitting element protecting device, comprising:
a light emitting diode;
a transistor for driving said light emitting diode;
a monolithic integrated circuit temperature transducer for detecting a temperature of said light emitting diode;
an inverter for inverting an output value from said monolithic integrated circuit temperature transducer; and
an AND circuit for outputting to said transistor an ANDed result of a transmission instructing signal and an output value from said inverter, so as to prevent said light emitting diode from being damaged.

9. A light emitting element protecting device, comprising:
light emitting means for emitting light based on a driving input;
driving means for driving said light emitting means based on an input signal; and
pulse controlling means for converting an input signal having an arbitrary pulse width into a pulse signal having a predetermined pulse width, and providing the pulse signal to said driving means, so as to prevent said light emitting means from being damaged.

10. The light emitting element protecting device according to claim 9, wherein said pulse controlling means is a monostable circuit.

11. A light emitting element protecting method, comprising the steps of:
detecting the size and the elapsed time of an electric current flowing into a light emitting element;
integrating the size of the electric current flowing into the light emitting element and the elapsed time the electric current has been flowing into the light emitting element; and
controlling the electric current flowing into the light emitting element to stop the current based on a result of the integration so as to prevent said light emitting element from being damaged.

12. A light emitting element protecting method, comprising the step of:
allowing an electric current flowing into a light emitting element to stop based on temperature of the light emitting element and the length of time the electric current has flowed into the element, so as to prevent said light emitting element from being damaged.

13. A light emitting element protecting method, comprising the steps of:
converting a driving signal which drives a light emitting element and has an arbitrary pulse width into a pulse signal having a predetermined pulse width; and
driving the light emitting element based on the pulse signal, so as to prevent said light emitting element from being damaged.

14. A light emitting element protecting device, comprising:
a converter to convert a driving signal having an arbitrary pulse width into a driving input having a predetermined pulse width;
a light emitting device emitting light based on the driving input;
a light detector detecting light output from said light emitting device and generating a signal;
light duration measuring device measuring the length of time light is output from said light emitting device; and
a controlling device preventing damage to said light emitting device based on the signal from said light detector and a signal from said light duration measuring device.

15. The light emitting element protecting device according to claim 14, wherein said light detector comprises a light intensity measuring device.

16. A method of protecting a light emitting device, comprising:
converting a driving signal having an arbitrary pulse width into a pulse input having an assigned pulse width,
the driving input driving
the light emitting device
detecting light being output from a light emitting device and the length of time light is being emitted from the light emitting device; and
controlling the assigned pulse width based on the detected light output and the length of light emission time so as to protect the light emitting device from damage.

17. The protecting method according to claim 16, wherein said detecting includes measuring light intensity.
